(19) United States
(12) Patent Application Publication
(10) Pub. No.: US 2008/0121083 A1
(43) Pub. Date: May 29, 2008

(54) PUNCHING APPARATUS

(76) Inventors: Ok-Hwan Kim, Gyeonggi-do (KR); Sang-Ho Lee, Seoul (KR)

Correspondence Address: MORGAN & FINNEGAN, L.L.P., 3 WORLD FINANCIAL CENTER, NEW YORK, NY, 10281-2101, US

(21) Appl. No.: 11/693,947

(22) Filed: Mar. 30, 2007

(30) Foreign Application Priority Data
Nov. 28, 2006 (KR) 10-5006-0118126

(51) Int. Cl. B26D 7/00

(52) U.S. Cl. 83/821

(57) ABSTRACT

A punching apparatus is disclosed. The apparatus includes an upper plate including a punching member having punching blade and guide blade with specific patterns, and upper jig to elastically support the punching member and having guide hole with the same pattern as the blade pattern; a lower plate including lower jig formed with punching hole having the same pattern as the blade pattern, and a guide protrusion to punch by variously changing positions of an object to be punched; and magnets independently provided at corresponding positions of the upper and lower plates, independent from each other, to face each other and to align the upper plate with the lower plate at a predetermined position. The punching can be freely performed at a desired position regardless of the position of the object to be punched and the object can have a continuous punched pattern.

### BACKGROUND OF THE INVENTION

1. Field of the Invention

The present invention relates to a punching apparatus, and more particularly, to a punching apparatus to punch a hole in a desired place freely regardless of the position of an object to be punched and to make a continuous pattern in the object.

2. Description of the Related Art

Generally, a punching apparatus is a device to punch a hole in a desired place of a photograph, a card, a letter, and the like (hereinafter, referred to as a “sheet”), may simply punch a circular shape in documents for the purpose of keeping the documents in custody. The punching apparatus can also provide an aesthetical pleasing hole to the sheet by punching the sheet in various decorative patterns, such as a flower pattern.

FIG. 1 schematically illustrates a conventional punching apparatus. The conventional punching apparatus includes a punching member 101 having a punching blade 102 of a specific pattern, an upper jig 111 having a guide hole 112 through which the punching blade 102 penetrates, a lower jig 113 having a punching hole 114 through which the punching blade 102 penetrates, and a base 121 to support the lower jig 113. Moreover, punching is performed only when the punching blade 102 of the punching member 101, the guide hole 112, and the punching hole 114 are precisely aligned with each other. IN alignment, the upper jig 111 and the lower jig 113 are integrally formed in a “U”-shape by a connecting portion 115 to connect ends of the upper jig 111 and the lower jig 113 to each other. Due to this, there is a predetermined gap between the upper jig 111 and the lower jig 113 such that the sheet to be punched is inserted into the gap.

The base 121 is provided with a reference plane (not shown) as a reference for the punching formed in the upper side thereof so that the punching can be performed using the reference plane in various ways.

Operation of the conventional punching apparatus will be described. A sheet to be punched is inserted into the gap between the upper jig 111 and the lower jig 113 and the punching member 101 is pressed downward so that the sheet is punched in the same pattern as that of the punching blade 102. After the sheet is arranged on the reference plane, various punched patterns can be changed according to a shape of the reference plane.

As the conventional punching apparatus, there is a Korean Registered Utility Model No. 20-0418709.

However, the sheet cannot pass through the connecting portion 115 when the sheet is inserted into the conventional punching apparatus. Thus, the insertion of the sheet is restricted by the connecting portion so that the place of the sheet where punching is carried out is limited to the margins of the sheet. Moreover, in order to obtain various patterned punched holes, the sheet must be cut in the same pattern as the punched hole.

### SUMMARY OF THE INVENTION

Therefore, the present invention has been made in view of the above and/or other problems, and it is an aspect of the present invention to provide a punching apparatus to punch a desired place freely regardless of a punching position of an object to be punched and to make a continuous pattern in the object.

In accordance with the present invention, the above and other aspects can be accomplished by the provision of a punching apparatus comprising: an upper plate including a punching member having a punching blade and a guide blade respectively with a specific pattern, and an upper jig to elastically support the punching member and having a guide hole with the same patter as the specific pattern; a lower plate including a lower jig formed with a punching hole having the same pattern as the specific pattern, and at least one guide protrusion to punch by variously changing a position of an object to be punched; and at least one magnet independently provided at corresponding positions of the upper plate and the lower plate, which are independent from each other, to face each other and to align the upper plate with the lower plate at a predetermined position.

Moreover, the guide protrusion has the same diameter as that of an outer circumference of the guide blade, guides the object to be punched in association with a hole punched by the guide blade, and is disposed on the lower plate such that a hole can be punched in the form of an edge shape, a straight line shape, a circular shape, and an oval shape in accordance with a punching position of the object to be punched.

The lower plate further comprises a guideline to connect the guide protrusion to the punched hole to guide the object to be punched, and the upper plate further comprises a guide plate to guide the object to be punched with an oval-shaped punched hole in association with the guide protrusion.

The oval shape is punched such that a semi-circular hole is punched, an end of the semi-circular hole is positioned at the guide protrusion, and the other end of the semi-circular hole is positioned at the punching position.

### BRIEF DESCRIPTION OF THE DRAWINGS

These and/or other aspects and advantages of the present invention will become apparent and more readily appreciated from the following description of the embodiments, taken in conjunction with the accompanying drawings, in which:

FIG. 1 is a sectional view illustrating a conventional punching apparatus;

FIG. 2 is a perspective view illustrating a punching apparatus according to an embodiment of the present invention;

FIG. 3 is an exploded perspective view illustrating the punching apparatus in FIG. 2;

FIG. 4 is a plan view illustrating the punching apparatus in FIG. 2;

FIG. 5 is a plan view illustrating the punching performed to linear margins and an edge of a sheet by the punching apparatus according to the embodiment of the present invention;

FIG. 6 is a plan view illustrating the punching performed in a circular shape by the punching apparatus according the embodiment of the present invention; and

FIGS. 7a and 7b are plan views illustrating the punching performed in an oval shape by the punching apparatus according to the embodiment of the present invention.

### DESCRIPTION OF THE PREFERRED EMBODIMENTS

Hereinafter, the preferred embodiments of the present invention will be described in detail with reference to the accompanying drawings.

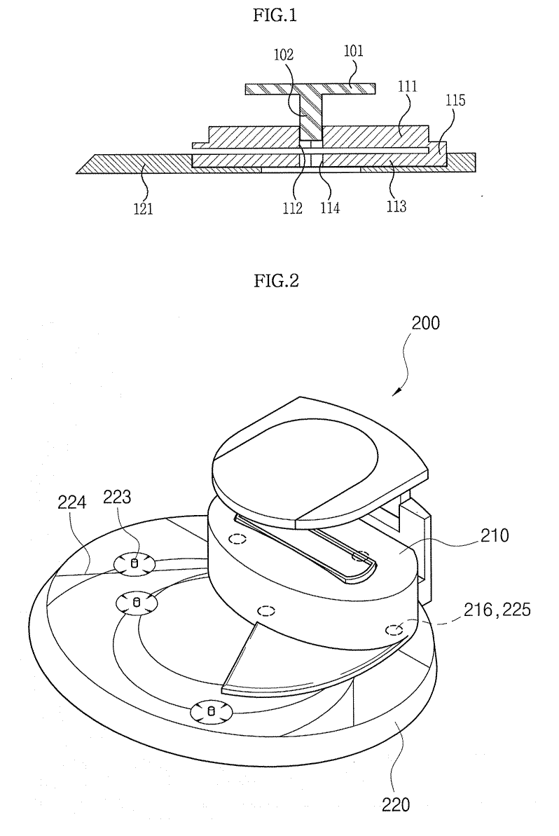

As illustrated in FIGS. 2 to 4, a punching apparatus 200 according to an embodiment of the present invention includes an upper plate 210 and a lower plate 220 independent from each other.

The upper plate 210 includes a punching member 214 and an upper jig 211 that are installed therein and a pressing member (not shown) to press the punching member 214 to punch an object to be punched.

The punching member 214 includes a punching blade 215 having a specific pattern and a guide blade 215a positioned adjacent to the punching blade 215.

The upper jig 211 has a guide hole 212 with the same shape as those of the punching blade 215 and the guide blade 215a. Here, the punching member 214 and the upper jig 211 are elastically supported by elastic bodies 213, and the elastic bodies 213 are preferably compression springs.

Meanwhile, the upper plate 210 further includes a guide plate 217 associated with a later-described guide protrusion to punch an object to be punched. The guide plate 217 has an inclined side into which the object is inserted. The upper plate 210 includes at least one magnet 216 installed in a lower side thereof.

The lower plate 220 includes a lower jig 221 having a punching hole 222 with the same shape as that of the guide hole 211 of the upper jig 211.

The lower plate 220 further includes a guide protrusion 223 to guide the object when the punching is performed and a guideline 224 to connect the guide protrusion 223 to the punching hole 222.

Plural guide protrusions 223 are arranged on the upper plate 220, and each of the guide protrusions 223 includes a circular guide protrusion 223a and an oval guide protrusion 223b. The number of the circular guide protrusion is plural such that various sized circular holes can be punched.

The guideline 224 includes a linear guideline 224a, a circular guideline 224b, and an edge guideline 224c, and is associated with the guide protrusions such that the object to be punched can be punched in various patterns.

Since the lower plate 220 includes an edge guide groove 228 formed at an upper side of the punching hole 222 associated with the edge guideline 224c such that an edge of the object to be punched can be punched.

Meanwhile, the lower plate 220 includes at least one magnet 225 installed at positions corresponding to the positions of the magnets 216 installed in the upper plate 210 such that the upper plate 210 can be aligned with the lower plate 220. Here, the magnets 216 and 225 preferably face each other with different polarities. In other words, when the polarity of the magnets 216 in the upper plate 210 have N-polarity, the polarity of the magnets 225 of the lower plate 220 have S-polarity.

Hereinafter, operation of the punching apparatus of the present invention will be described with reference to the drawings.

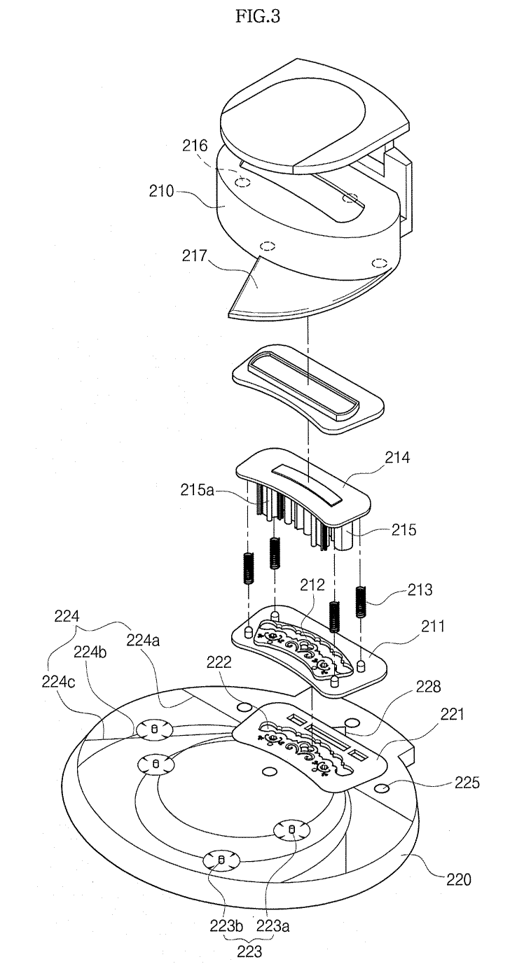

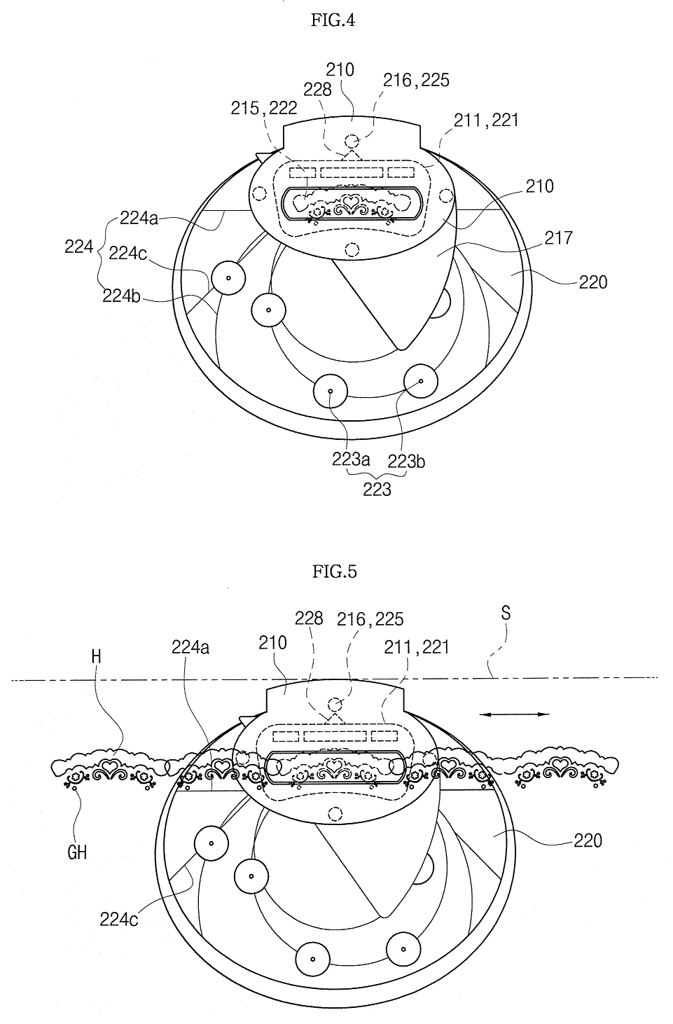

As illustrated in FIGS. 3 and 4, the object S to be punched is positioned between the upper plate 210 and the lower plate 220, and the upper and lower plates 210 and 220 are aligned with each other at a predetermined position by the magnets 216 and 225. When the punching member 214 and the upper jig 211, which are sequentially installed to the upper plate 210 and are supported to each other by the elastic bodies 213, are pressed by the pressing member (not shown), the punching blade 215 and the guide blade 215a of the punching member 214 move down to the guide hole 212 of the upper jig 211. The descending punching blade 215 and the guide blade 215a contact the punching hole 222 of the lower jig 221 to punch the object S. In this case, the object S may have various punched holes due to the guide protrusions 223, the guidelines 224, and the edge guide groove 228, which are formed in the lower plate 220.

Next, the punching of the object S using the linear guideline 224a will be described with reference to FIG. 5. When an end of the object S is arranged to the linear guideline 224a formed in the lower plate 220 and the upper plate 210 is placed on the object S, the upper and lower plates 210 and 220 are aligned with each other by the magnets 216 and 225. Then, when the punching member is pressed, a hole H is formed in the object S. After the upper plate 210 is separated from the lower plate 210 and the object S is moved by a predetermined distance in a direction to punch another hole adjacent to the punched hole H, a series of holes H communicated with each other are punched. Here, although not depicted in the drawings, if the same pattern as the shape of the punched holes is formed along the linear guideline 224a, the punching can be more precisely performed.

Meanwhile, although not depicted in the drawings, the object can be punched by matching the edge of the object S to the edge guide groove 228 and the edge guideline 224c.

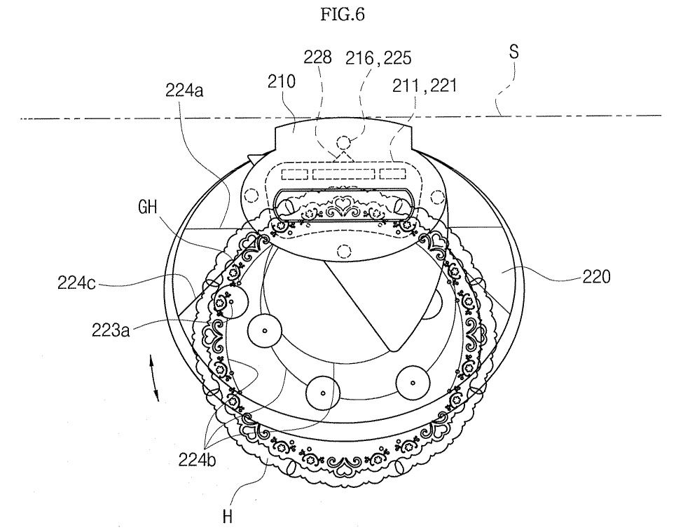

Next, the punching of the object S using the circular guideline 224b and the circular guide protrusion 223a will be described with reference to FIG. 6.

Since the coupling between the upper and lower plates 210 and 220 is identical to the above-description, its description will be omitted. A pattern hole H formed by the punching of the object S and a guide hole GH formed by the guide blade are formed in the object S. In this case, when a side of the pattern hole H is placed at the circular guide protrusion 223a and formed in the lower plate 220 in order to form a circular shape using the guide hole GH, the other side of the fixed guide hole GH is positioned at the upper plate 220 so that an end of the pattern hole H can be punched. As such, the pattern hole H is moved and punched along the circular guide protrusion 223a in a direction, a series of the pattern holes H communicates with each other and then becomes a single circle due to a final punching. Due to the above-described method, a semi-circular hole can be punched. Moreover, the numbers of the circular protrusion 223a and the circular guideline 224b are plural so that size of the punched circle can be variously changed.

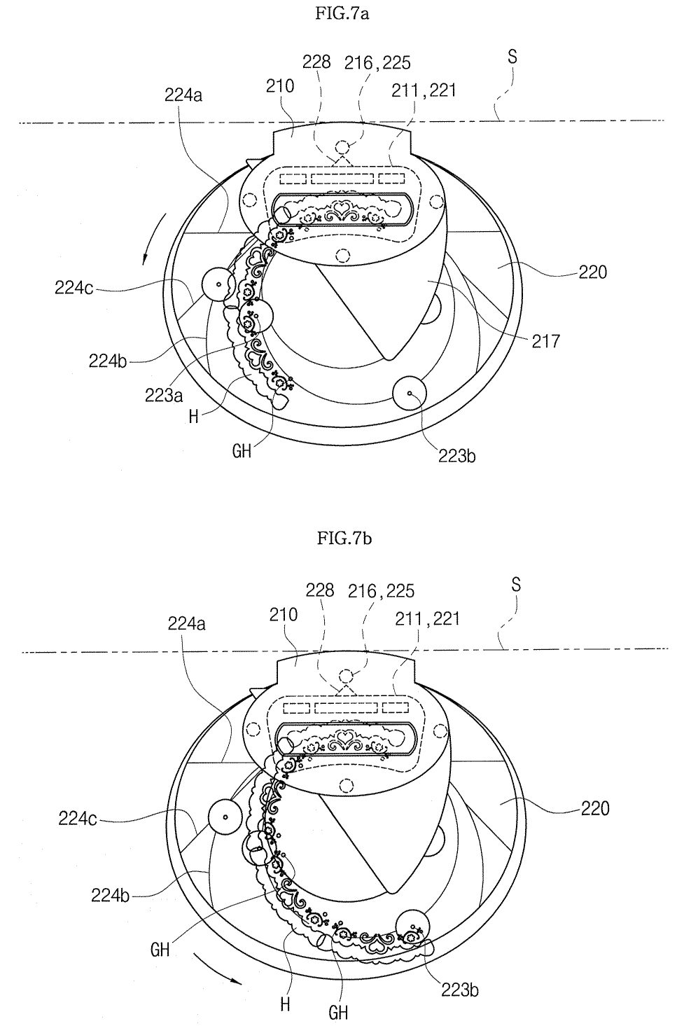

Next, the punching of the object S using the oval guide protrusions 223b will be described with reference to FIGS. 7a and 7b.

Like the description related to FIG. 6, a semi-circular hole is formed in the object S using the circular guide protrusions 224a and the circular guidelines 224b. the guide hole GH positioned at one of ends of the semi-circular hole is inserted into and fixed to the oval guide protrusion 223b, and a side of the guide plate 217 formed in the upper plate 210 is aligned with the ends of the semi-circular hole so that a curved portion of the semi-circular hole is positioned at a lower side. Here, as illustrated in FIG. 7b, when the guide hole GH punched in the semi-circular shape is punched along the semi-circular hole, the oval shaped hole is formed.

According to the punching apparatus of the present invention, the punching can be freely performed at a desired position regardless of a punching position of the object to be punched and the object can have a continuous punched pattern.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A punching apparatus comprising:
an upper plate including a punching member having a punching blade and a guide blade respectively with a specific pattern, and an upper jig to elastically support the punching member and having a guide hole with the same patter as the specific pattern;
a lower plate including a lower jig formed with a punching hole having the same pattern as the specific pattern, and at least one guide protrusion to punch by variously changing a position of an object to be punched; and
at least one magnet independently provided at corresponding positions of the upper plate and the lower plate, which are independent from each other, to face each other and to align the upper plate with the lower plate at a predetermined position.

2. The punching apparatus according to claim 1, wherein the guide protrusion has the same diameter as that of an outer circumference of the guide blade.

3. The punching apparatus according to claim 2, wherein the guide protrusion guides the object to be punched in association with a hole punched by the guide blade.

4. The punching apparatus according to claim 3, wherein the guide protrusion is disposed on the lower plate such that a hole can be punched in the form of an edge shape, a straight line shape, a circular shape, and an oval shape in accordance with a punching position of the object to be punched.

5. The punching apparatus according to claim 4, wherein the lower plate further comprises a guideline to connect the guide protrusion to the punched hole to guide the object to be punched.

6. The punching apparatus according to claim 1, wherein the upper plate further comprises a guide plate to guide the object to be punched with an oval-shaped punched hole in association with the guide protrusion.

7. The punching apparatus according to claim 4, wherein the oval shape is punched such that a semi-circular hole is punched, an end of the semi-circular hole is positioned at the guide protrusion, and the other end of the semi-circular hole is positioned at the punching position.
